(19) United States
(12) Patent Application Publication
(10) Pub. No.: US 2009/0036547 A1
(43) Pub. Date: Feb. 5, 2009

(54) INSECTICIDAL COMPOSITION

(75) Inventors: Sujay A. Shah, London (GB); Nigel Hill, London (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Livie Biopesticides Limited, London (GB)

(21) Appl. No.: 11/816,525

(22) PCT Filed: Feb. 8, 2006
(86) PCT No.: PCT/GB2006/000438

§ 371 Date: Apr. 25, 2008

(30) Foreign Application Priority Data
Feb. 17, 2005 (GB) 0503359.2

(51) Int. Cl. A01N 27/00; A01P 7/04

(52) U.S. Cl. 514/764

(57) ABSTRACT

The present invention relates to the use of a composition comprising cymene as a larvicide against mosquito larvae of a genus other than Culex and as an adulticide against mosquito adults.

### FIELD OF INVENTION

The invention relates to the use of an insecticidal composition against mosquitoes.

### BACKGROUND TO THE INVENTION

Biting insects which carry human diseases are of considerable concern. Worldwide, around 150 million people are infected with insect-borne diseases each year, with an annual death toll of 2 to 3 million people, mostly from malaria, in sub-Saharan Africa. Mosquitoes can carry a variety of different diseases, for example malaria, Dengue, Dengue haemorrhagic fever and yellow fever.

A number of drugs are available to treat and/or prevent some insect-borne diseases. However, not all diseases transmitted by mosquitoes can be treated efficiently. For example, there is no chemotherapeutic drug or vaccine available against the Dengue virus. Furthermore, in the case of antimalarial drugs, treatment with the drugs currently available is becoming less effective due to increased resistance in some Plasmodium strains. Plasmodium enters the human bloodstream as a consequence of the insect bite and causes malaria. Therefore, one of the most effective ways to prevent insect-borne illnesses is by preventing mosquito bites in the first place.

In an attempt to reduce the problems associated with disease-transmitting insects, a wide range of insecticides and insect repellents have been developed. Mosquitoes can be targeted with insecticides when they are in a larval state or once they have developed into adults. Accordingly, insecticides which are used to kill larvae are termed larvicides whereas insecticides that are used to specifically target adult insects are called adulticides. Most of the insecticides commonly used in public health measures to prevent the spread of disease are targeted against the adult mosquito and in particular against the female adult mosquito.

The organochlorine DDT was the most widespread compound used worldwide as an adulticide until it was withdrawn from use in most areas due to concerns over its build-up in the environment and effects on human health. Since then, organophosphates such as malathion, carbamates and propoxur are widely used in vector control programmes in most parts of the world although they are steadily being replaced by a class of compounds named pyrethroids.

One of the major drawbacks to the use of insecticides for larval control is the potential risk of environmental contamination and indiscriminate effects on non-target organisms. Pyrethroids, currently the most widely used class of pesticides in adult mosquito control, have shown high toxicity to fish and other aquatic life and are therefore seldom used against mosquito larvae.

One of the most important problems associated with pyrethroids, like their predecessors, is that resistance is already beginning to be found in many insect species in several parts of the world. Pyrethroid resistance, caused either by specific detoxification enzymes or an altered target site mechanism (kdr-type mutations in the sodium channels), has been reported in most continents in the majority of medically important mosquitoes species, such as Anopheles gambiae in East Africa and Aedes aegypti in Asia. If resistance continues to develop and spread at the current rate, it may render such insecticides ineffective in their current form in the not too distant future. Such a scenario would have potentially devastating consequences in public health terms, since there are as yet no obvious alternatives to many of the uses of pyrethroids. Therefore, it is necessary to develop new and effective insecticides.

The three major genera of medically important mosquitoes which transmit diseases are Anopheles, Culex and Aedes. These three genera differ in their behaviour, in particular with regard to habitats and feeding patterns. To develop efficient control measures, it is important to take the ecology and behaviour of the particular mosquito genus into account.

Anopheles species are vectors of human malaria and are responsible for the deaths of over 2 million people each year. While 90% of malaria cases occur in Africa, other regions, such as Central and South America and Asia, are also affected.

The infected insects carry a strain of the parasite Plasmodium. Anopheles will only breed in clean, fresh and unpolluted water, although a few species can withstand brackish water in coastal areas. Major larval breeding sites include rice fields, stored drinking water vessels, small ponds and puddles, flooded areas, marshland and areas of slow flowing waterways, particularly in the presence of aquatic vegetation.

As with all mosquitoes, only the females bite and require a blood meal to produce a batch of eggs which are normally laid 2 to 3 days post feeding. Anopheles species are night-biting insects and in many cases they seek a host only very late at night. Feeding behaviour varies between species: some feed on a variety of animal hosts (zoophilic), whilst others, many of which are important vectors of malaria, feed exclusively on man (anthropophilic). As well as differences in the time of biting and the choice of host, anopheline mosquitoes differ in their preference for feeding indoors (endophagic) or outdoors (exophagic). Anopheles species also differ in their post-feeding resting behaviour, which may be indoors (endophilic) or outdoors (exophilic). Control of Anopheles species is generally carried out using adulticides, in particular against endophagic species. Furthermore, organophosphates are employed to target Anopheles larvae. Pyrethroids are seldom used for Anopheles larvae control due to their toxicity in aquatic environments.

Another medically important mosquito genus is Culex. Culex species are vectors of lymphatic filariasis (elephantiasis), Japanese Encephalitis, Rift Valley fever and arboviruses, such as the West Nile Virus.

Female Culex feed from dusk to dawn either indoors or outdoors and they can often be found in urban areas. Culex species lay eggs in polluted water, such as urban drains, stagnant pools and cess pits or latrines. Culex larvae, which develop from eggs in these habitats, require a high organic matter content and are adapted to low oxygen levels. Once breeding sites of Culex are identified, those sites that cannot simply be removed are treated with larvicides. As Culex breeding sites tend to be polluted water, it is not necessary to consider the health effects of the larvicide when ingested by humans. Accordingly, the choice of compounds is less restricted than that available for anopheline control. Therefore, long-term control of Culex is more frequently aimed at larvae than at adults. However, mosquito control by adulticides may also be useful, particularly at times of arbovirus outbreaks.

A third mosquito genus of great medical importance is Aedes as female Aedes transmit the Dengue virus and Yellow fever. Dengue is endemic in more than 100 countries in Africa, Central and South America, South-east Asia and the Western Pacific. Female Aedes lay eggs in isolated and often small enclosed containers, where rain water has collected. Typical breeding sites include discarded rubbish (bottles, boxes and cans), stored tyres and household drinking water containers. Eggs are laid just above the water level and are able to survive desiccation for weeks or months before an influx of water covers them and whereupon they hatch.

Unlike other mosquito species, female Aedes undertake host seeking and feeding during daylight hours and mostly outdoors. This behaviour makes adult control difficult. Therefore, some conventional uses of adulticides are less suitable for Aedes control, although adult control may be useful during disease outbreaks. However, larval control is a primary means of Dengue control, although the diversity and number of sites can make good coverage difficult.

Indian Patent application No. 454/DEL/2001 relates to a process for the preparation of an insecticidal composition. The document neither discloses the use of an insecticidal composition to treat larvae of mosquito genera other than Culex nor the use of the composition as an adulticide. The contents of this document are hereby incorporated by reference.

The present inventors have surprisingly found that a formulation comprising cymene can be used as a larvicide against mosquitoes of a genus other than Culex. Furthermore, they have also shown that such formulations can be used as adulticides to target adult mosquitoes, in particular as such formulations can be used as contact insecticides. Formulations commonly used as larvicides are almost never suitable for use as adulticides.

### SUMMARY OF THE INVENTION

Viewed from a first aspect, the invention provides the use of a composition comprising cymene, preferably p-cymene, as a larvicide against mosquito larvae of a genus other than Culex.

The use of a composition comprising thymol and/or cymene as a larvicide against mosquito larvae of a genus other than Culex can also be provided. It is also to be understood that where cymene is mentioned in the specification, the term can be replaced with thymol and/or cymene.

Viewed from a second aspect, the invention also provides granules comprising a formulation comprising cymene.

The invention also provides the use of granules comprising a formulation comprising cymene as a larvicide against mosquito larvae.

Viewed from a further aspect, the invention provides the use of a composition comprising cymene as a mosquito adulticide.

In accordance with another aspect of the invention, there is provided a composition comprising cymene which is coated on and/or absorbed into a fabric.

In accordance with another aspect of the invention, there is provided a composition comprising cymene formulated as a residual spray.

### DESCRIPTION OF THE INVENTION

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In accordance with the first aspect of the invention, there is provided the use of a composition comprising cymene as a larvicide against mosquito larvae of a genus other than Culex. Preferably, the larvae are selected from the genera Anopheles or Aedes. Thus a preferred genus is the genus is Anopheles, in particular, species selected from the group consisting of Anopheles gambiae, Anopheles stephensi, Anopheles albimanus. Another preferred genus is Aedes, in particular species selected from the group consisting of Aedes aegypti and Aedes albopictus.

As will be appreciated by the skilled person, certain strains of any of these species may be resistant against conventionally used insecticides. Accordingly, the invention as disclosed herein also relates to the use of a composition comprising cymene as a larvicide against those mosquito strains which have developed resistance against conventionally used insecticides, such as the strains listed in the examples, e.g. Anopheles gambiae, Anopheles stephensi and Anopheles albimanus.

Preferably, the composition is a plant extract, such as an essential oil. Particularly, the extract is derived from Rabdosia melissoides or other plants comprising cymene, such as Thyme (Thymus vulgaris L; Thymus ssp), Monarda punctata L. Savory (e.g. Satareja hortensis), Cumin (e.g. Cuminum cyminum) and Labiatae. A “plant extract” according to the invention is an extract from plant material. “Plant material” is defined as a plant or a part thereof (e.g. bark, wood, leaves, stems, inflorescence, roots, fruits, seeds or parts thereof). The extract may be prepared from plant material by one or more of the following processes: pulverisation, decoction, expression, aqueous extraction, ethanolic extraction or other processes known in the art. A plant extract may, but preferably does not, constitute a highly purified substance derived from natural sources and will generally also contain other plant-derived substances. Thus, in the case of cymene, a plant extract derived from one or more plants will not generally include highly purified, pharmaceutical-grade cymene. However, a skilled person will appreciate that a plant extract may be further purified to obtain highly purified substances. Furthermore, the composition which is used as larvicide or adulticide may also preferably comprise synthetically prepared and therefore highly pure compounds. In particular, the composition may comprise synthetic cymene.

The insecticidal composition which is used according to the invention comprises cymene, preferably p-cymene, alone as the active ingredient. The composition may also comprise a solvent. The active ingredient is preferably present in an amount of 1 to 50% w/w and preferably about 10% w/w. Suitable solvents according to the invention include one or more surfactants such as calcium dodecylbenzene sulfonate, polyoxyethlenated alkyl phenols, sorbitan or sorbitan polyoxyethlenated esters or sodium petroleum sulphonate, Hyoxid X 45, Atlox 3400B, Emulsol M A, Tween 40, Tween 80, Span 40, Unitox 33 X and IGSRF-6000 or other surfactants known in the art. These surfactants may be used alone or in combination. A preferred surfactant comprises a mixture of Tween 40 and Span 40 in a ratio of 9:1 to 1:9, preferably 9:1 or Unitox 33X and IGSRF-6000 in a ratio of 9:1 to 1:9, preferably 9:1. Preferably, the final volume is made to obtain about 10-25% w/w of the active ingredient and about 5-10% of calcium dodecylbenzene sulfonate, polyoxyethlenated. alkyl phenols, sorbitan or sorbitan polyoxyethlenated esters or sodium petroleum sulphonate, Hyoxid X 45, Atlox 3400B, Emulsol M A, Tween 40, Tween 80, Span 40, Unitox 33 X and IGSRF-6000 or other surfactants known in the art. Solutions of the composition may also contain one or more appropriate solvents selected from, for example, cyclohexanone, ceenine, ethanol, aromax, iomax, xylene, ethyl lactate, methyl oleate, silicon/acetone or olive oil.

The insecticidal composition of the present invention may be employed alone or in the form of mixtures with such solid and/or liquid dispersible carrier vehicles if desired, or in the form of particular dosage preparations for specific application made therefrom, such as solutions, emulsions, suspensions, powders, pastes, and granules which are thus ready for use. The insecticidal composition can be formulated or mixed with, if desired, conventional inert diluents or extenders of the type usable in conventional insecticide formulations or compositions, e.g. conventional insecticide dispersible carrier vehicles such as gases, solutions, emulsions, suspensions, emulsifiable concentrates, spray powders, pastes, soluble powders, dusting agents, granules, foams, pastes, tablets, aerosols, natural and synthetic materials impregnated with active compounds, microcapsules, coating compositions, and formulations used with burning equipment, such as fumigating cartridges, fumigating cans and fumigating coils, as well as ULV cold mist and warm mist formulations.

As mosquito larvae are generally found in water, larvicides are preferably formulated so that they are particularly effective for use in water. Accordingly, formulations used as larvicides are preferred to be to be water-soluble or miscible since they are diluted in water before use to achieve an appropriate concentration. Liquid treatments can be applied by spraying. Formulations include water-soluble powders (SP), soluble (liquid) concentrates (SL), wettable powders (WP) or water-dispersible granules (WG). Solid formulations such as granules or briquettes, where the active ingredient is mixed with bulking agents such as sawdust, sand or plaster, can easily be used by introduction of the formulation into water containers such as tanks or latrines. On the other hand, emulsifiable concentrates are generally ineffective for long term use in water as larvicides since they will settle after about 24 hours. For the treatment of water, it is of particular benefit to formulate the composition so that the active ingredients will be released slowly over a period of time. This avoids the need for continuous re-treatment.

The present inventors have found that effective treatment of larvae-infected water can be provided over a period of several months by using granules to release the formulation comprising cymene.

Accordingly, the invention provides granules comprising a formulation comprising cymene. The invention also provides the use of such granules as a larvicide against mosquito larvae.

Preferably, granules of this invention are used as larvicides against mosquitoes of the genera Anopheles, Aedes or Culex. A preferred genus is Anopheles, in particular the species are selected from the group comprising Anopheles gambiae, Anopheles stephensi, Anopheles albimanus. Another preferred genus is Aedes, in particular species selected from the group of Aedes aegypti and Aedes albopictus. Another preferred genus is Culex, the preferred species being Culex pipiens and Culex quinquefasciatus.

Granules according to the invention can either have the insecticide impregnated on a pre-formed granule or they can be mixed with a filler to form slow-release granules. Granules can be formulated so that the active ingredient is released at a specific time by coating the granules with a polymer which will be broken down over a predictable time. Appropriate polymers are known to those skilled in the art.

Granular pesticide formulations differ from powder formulations in their mesh size. The size of granules is generally in a range of from 16-60 British standard (BS) mesh (250-1,000 microns) with at least 90% of the granules within the specified mesh size range. The large size of granules prevents them from drifting in the wind resulting in much less loss of pesticide than with powder and liquid formulations. The active ingredient in granules is usually present in a concentration of from about 1% to about 40% w/w.

Different absorbent carriers may be used for granular formulations according to the invention. They are characterised by their absorptive capacity which is a function of the polymorphic crystalline structure and the surface area of the carrier particles. Absorbent carriers may be of mineral origin and include silicate clays, such as attapulgite (absorptive capacity 100), montmorillonite (absorptive capacity 45), kaolin (absorptive capacity 44), talc (absorptive capacity 30) or diatomites; and carbonates, such as calcium carbonate (absorptive capacity 12) or dolomite. Carriers may also include synthetic material, such as precipitated silica, silica (absorptive capacity 200) or fumed silica. Furthermore, carriers may also include botanicals, for example corn cob grits (absorptive capacity 70), rice hulls or coconut shells. The absorptive capacities refer to the mean absorption oil capacity in g/100 g (Knowles in “Chemistry and Technology of Agrochemical Formulations”, Kluwer Academic Publishers, 1998).

Another important parameter for the characterisation of granules is the particle size distribution of the carrier which determines the number of particles (and thus available surface area) available to absorb oil. The average number of particles per gram for carrier depends on the mesh size. For example, the average number of particles per gram for attapulgite at a mesh size range of 500-1,000 microns is 2,700, at a mesh size range of 425-850 microns it is 5,000 and 20,300 at a mesh size range of 300-600 microns. At a mesh size range of 250-500 microns, the average number of particles per gram for attapulgite is 24,800.

In summary, to be effective, the carriers for granular formulations must not only be compatible with the active ingredient but they must also have a good absorptive capacity for liquids. Furthermore, good carriers are characterised by a good mechanical strength and slow disintegration on contact with the target. Carriers must also be free-flowing and non-caking.

In general, the bulk density of the carriers affects their absorptive capacity and the loading of the granules to the applicator. Mineral-based carriers may have acid sites on the particle surfaces which could cause decomposition of the active ingredient. This may be overcome by adding 1-2% of a stabiliser such as epoxidised linseed oil. The mechanical strength of extruded and uncalcined carrier preformed granules is generally good, while botanical carriers are very resistant to mechanical breakdown.

Different methods for the preparation of granular formulations are known in the art, including coating wherein a fine pesticide powder is coated onto carrier granules, e.g. sand, in a blender using sticker solutions. Another method of impregnation involves spraying a solvent-based solution of pesticide onto an absorbent carrier in a blender. Granules can also be prepared by extrusion wherein pesticides which have very low water solubility can be processed by mixing a powder blend with a small amount of water to form a paste, which is then extruded and dried if necessary.

In each method, the resultant granules can be spray-coated with resins or polymers to control the rate of release of the pesticide after application.

Typically, a granular formulation will comprise 1-40% w/w of active ingredient, 1-2% w/w of stabiliser, 0-10% w/w of polymer or resin, 0-5% w/w of surfactant, 0-5% w/w of binder and up to 98% w/w carrier.

Specialist granules include so-called “smart granules” which are designed for direct application to rice paddy water or other water courses, releasing active ingredient away from root zones, primarily at the water surface as a floating oil. “Smart granules” may also be used according to the invention.

Advantageously, “smart” granules permit a thin film of oil, containing active ingredient, to be spread over a water surface to give a better distribution than that permitted conventional granule formulations. The oil films are usually sticky and resist dispersal by weather. In a typical example, an active ingredient is dissolved or dispersed in an oil or solvent of low volatility and the resultant liquid is then incorporated into a suitable granular carrier. The granule is designed to sink in water and release the active ingredient contained in the oil, which then floats to the water's surface.

In addition to preventing the spread of disease by targeting mosquito larvae, it is also important to develop compositions which can be used against infected adult mosquitoes which spread the disease through bites.

Therefore, the present invention also provides the use of a composition comprising cymene as a mosquito adulticide. According to the present invention, a single composition can therefore be used to target both larvae and also adults depending on the way in which it is formulated.

Preferably, the invention relates to the use of an adulticide comprising cymene, preferably p-cymene, against mosquitoes selected from the genera of Anopheles, Aedes or Culex. A preferred genus is Anopheles, in particular the species are selected from a group comprising Anopheles gambiae, Anopheles stephensi, Anopheles albimanus. Another preferred genus is Aedes, in particular species selected from the group of Aedes aegypti, Aedes albopictus. Another preferred genus is Culex, the preferred species being Culex pipiens and Culex quinquefasciatus.

Use of adulticides generally takes three main forms: residual surface treatment, space spraying (fogging) and use of Insecticide Treated Nets (ITNs). Bed nets are nets fixed over beds or other sleeping areas to create a physical barrier between mosquitoes and a human sleeping beneath.

In fogging, the pesticides are formulated into oil solutions which enable them to be blown as droplets into the air. Depending on the target distance to be covered, the size of the droplet required, and the machinery available to apply it, fogging can be through the use of “mistblowers” (droplet size 50-80 μm), “foggers” (hot or cold droplets <50 μm) or the use of “Ultra-Low-Volume” (ULV) in which the amount of active is dispersed in a high volume of solvent. In public health use against mosquitoes, the most widely used method is fogging, in particular thermal fogging (a method which uses hot air). Fogging is periodically used in areas with high mosquito numbers or during outbreaks of diseases such as Dengue or West Nile Virus, for example in the USA.

Thus, the use of the adulticide according to the invention also comprises a use wherein the adulticide is formulated for fogging. The invention therefore provides a composition comprising cymene suitably formulated for fogging.

In one embodiment, the invention provides a composition formulated as ultra-low volume (ULV) formulations comprising cymene. Another aspect of the invention relates to the use of ULV formulations which comprise a composition comprising cymene as a mosquito adulticide against mosquitoes selected from the genera of Anopheles, Aedes or Culex. A preferred genus is Anopheles, in particular the species are selected from a group comprising Anopheles gambiae, Anopheles stephensi, Anopheles albimanus. Another preferred genus is Aedes, in particular species selected from the group of Aedes aegypti, Aedes albopictus. Another preferred genus is Culex, the preferred species being Culex pipiens and Culex quinquefasciatus.

ULV formulations are generally liquid, usually oil-based, formulations which may be undiluted through specialist equipment at volumes of less than 5 to 50 litres per hectare. Application can be by aerial or ground equipment.

ULV formulations have to satisfy particular physical criteria for successful application which usually depend on active ingredient dissolved, dispersed or emulsified in low volatile solvents or oils.

Typical formulations used in UVL applications include ultra-low volume liquids; ultra-low volume suspensions; water-in-oil emulsions which are fluid, heterogeneous formulations consisting of a solution of pesticide in water, dispersed as, fine droplets in a continuous organic liquid phase; oil-miscible liquids, a homogeneous liquid concentrate for low or ultra-low volume application after dilution in organic liquid; oil-miscible suspension, a stable suspension of active ingredient for low or ultra-low volume application after dilution in organic liquid; and oil-dispersible powder, a powder formulation for dispersion in organic liquid and subsequent low or ultra-low volume application.

ULV solutions are useful for liquid active ingredients or for ingredients which are soluble. ULV solutions should have suitable physical properties such as low viscosity and viscosity index (i.e low variation of viscosity with temperature) and low volatility. The solvent selected should have good solvency for the active ingredient and good crop safety. In practice a compromise is made, using blends of aromatic solvents and mineral oils to obtain the required properties.

ULV solutions may also contain adjuvants, e.g. oil-soluble surfactants, to improve biological properties.

Active ingredients may also be provided as concentrated solutions in solvent/oil combinations. These concentrates are multi-purpose formulations designed to be diluted in a suitable low-volatile organic liquid before application as low or ultra-low volume sprays, or by other techniques such as fogging or misting.

Active ingredients may also be provided as dilute solutions in solvent/oil combinations as spreading oils for direct application to water.

For ground application of ULV formulations, formulation viscosity is important for correct flow rate through gravity-fed equipment. As for aerial ULV formulations, in particular a low viscosity index (i.e. low viscosity variation with temperature) is preferable.

A typical ULV solution may consist of active ingredient (1-80% w/w), adjuvant (for bio-enhancement, retention or rainfastness, 0-20% w/w), viscosity modifier (0-10% w/w), primary solvent (5-50% w/w), low volatile co-solvent or oil (5-50% w/w).

ULV suspensions are used for non-aqueous concentrate and solid active ingredients that are not readily soluble. The active ingredient is finely dispersed in an oil medium, usually by a bead milling process and using a suitable dispersing agent. Sometimes concentrated oil suspensions are made; these are designed for dilution in suitable oils before application as low volume or ULV sprays, or by other techniques such as thermal or cold fogging.

Apart from similar requirements to ultra-low volume liquid formulations above, ultra-low volume suspension formulations must be stabilised against settling and claying on long-term storage, in an analogous way to aqueous suspensions concentrates. However, organophilic swelling clays or silicas as are known in the art must be used as stabilisers in these formulations.

A typical ULV suspension formulation may consist of active ingredient (2-40% w/w); dispersing agent (0.5-5.0% w/w); bio-enhancing adjuvant(0-20% w/w); anti-settling agent(s) (0.1-2.0% w/w); oil continuous medium (to 100% w/w).

The minimum application of ULV formulations is 5 litres per hectare. To obtain good cover, it is necessary to produce fine droplets of a diameter of less than 200 microns (μm). Aqueous sprays cannot normally be used since droplets with a smaller diameter than 200 μm will evaporate rapidly. Hence ULV formulations are normally based on a non-aqueous liquid system giving low evaporation rates. To ensure even coverage ULV formulations must be applied as very fine droplets, usually below 100 μm.

The invention also relates to a composition comprising cymene formulated as a residual spray. The residual spray can be used against mosquitoes selected from the genera of Anopheles, Aedes or Culex. A preferred genus is Anopheles, in particular the species are selected from a group comprising Anopheles gambiae, Anopheles stephensi, Anopheles albimanus. Another preferred genus is Aedes, in particular species selected from the group of Aedes aegypti, Aedes albopictus. Another preferred genus is Culex and the preferred species are Culex pipiens and Culex quinquefasciatus.

In residual surface treatment, a long-lasting formulation of the insecticide is sprayed, usually from a hand-held pressure spray pack, onto a surface leaving a residue on the surface. In most cases, the formulation used is a wettable powder and the activity of the residual compound on mud walls and thatched roof material lasts around 6 months before re-treatment is required. The use of longer lasting, or less hazardous, formulations such as micro-emulsions, suspension concentrates or capsule suspensions is being evaluated but as yet these formulations have not replaced the earlier formulations in most areas. Benefits of residual spraying over fogging include less contamination of the environment and that the technique tends to expose only the females of a population to resistance selection pressure.

The invention also provides a composition comprising cymene which is coated on and/or absorbed into a fabric. The invention also relates to the use of the adulticide wherein the adulticide is formulated for the treatment of bed nets.

The fabrics coated with cymene-containing compositions are generally woven materials. These fabrics may be made from natural or synthetic fibres.

Bed nets are useful against mosquitoes selected from the genera of Anopheles, Aedes or Culex. A preferred genus is Anopheles, in particular the species are selected from a group comprising Anopheles gambiae, Anopheles stephensi, Anopheles albimanus. Another preferred genus is Aedes, in particular species selected from the group of Aedes aegypti, Aedes albopictus. Another preferred genus is Culex and the preferred species are Culex pipiens and Culex quinquefasciatus.

An untreated net, such as a bed net only acts as a physical barrier, so if it has a hole, or it is not tucked in, the insect will still be able to enter and bite. Similarly, if a limb is placed against the net a female is generally able to bite through. To overcome these deficiencies, there has been a move in recent years to impregnate nets, preferably, bed nets, with fast-acting contact insecticides which interacts to kill any mosquito coming into contact with the surface.

The only compounds currently in use for ITNs are synthetic pyrethroids, as these are the only class of actives and which can be used at very low doses (typically 500-25 mg/m²), has a very fast knockout and kill of insects, and has a very high human safety profile. Pyrethroids are the only insecticides currently recommended by the World Health Organisation (WHO) for treatment of mosquito nets. Pyrethroids act as contact insecticides (a contact insecticide is defined as one that does not repel insects but kills or stuns the mosquitoes upon contact of the insect with the compound or a surface treated with it). This rapid knockout is very important as it immediately prevents the insect from biting or further movement. Accordingly, adulticides are particularly efficient if they act as contact insecticides providing a rapid knockout of the insect. Since larvae are restricted in their movement compared to adult insects, larvicides are not required to provide instant or rapid knockout. Therefore, larvicides are by no means always effective for use as adulticides.

Contact insecticides can be used in producing ITNs or as residual sprays for the treatment of indoor walls.

Accordingly, the invention preferably relates to the use of the adulticide as a contact insecticides.

Studies on malaria have shown that the use of bed nets impregnated with a contact insecticide is useful in reducing the risk of transmission of disease and the promotion of the use of insecticide-treated nets has become a key malaria control strategy adopted by the WHO. Use of ITNs has been particularly successful in sub-Saharan Africa in reducing malaria morbidity and mortality as the local vector, Anopheles gambiae, feeds indoors and very late at night. Further advantages include the fact that only females are exposed, thus reducing resistance selection pressure on both sexes, and the fact that small amounts are used in a very localised manner reducing cost and contamination. ITNs remain active for around 6 to 12 months so re-treatment is infrequent and readily achieved by re-dipping the fabric in diluted insecticide.

The insecticide used for such dipping is typically formulated as an emulsifiable concentrate (EC). Therefore, the use according to the invention relates preferably to the use wherein the composition is formulated as an EC.

Generally, a 25-50% solution of the insecticide in a solvent is used and at least 10% solubility is typically needed to make the formulation economic to transport. In many cases, insecticides are soluble in organic solvents but not in water. In addition to appropriate solvents, emulsifiers are added to ensure that a fine oil drop (1-2 nm) in water emulsion is produced when the formulation is diluted with water. The resultant emulsion appears opaque and does not settle for 24 hours. ECs are a convenient way of formulating water-insoluble ingredients and they do not cause nozzle abrasion. ECs are mixed with water, then the net is dipped into the solution, wrung and left to dry. ECs according to the invention are preferably a 10% or 25% solution by weight.

Adulticides are also used to impregnate not only bed nets, but also other protective materials that may create a physical barrier between the human target and the mosquito, for example tents or clothing.

Accordingly, in another aspect, the invention relates to a composition comprising cymene which is coated on and/or absorbed into a fabric, such as a tent and any item of clothing, such as T-shirts, shirts or trousers.

In addition to providing protection from insect bites for local populations, fabric impregnated with an insecticide has become very popular amongst travellers visiting countries where disease is spread through mosquito bites. While diseases transmitted by mosquitoes are a great danger to the population in many countries in Africa, South America, the Americas and Asia, infection is also of concern to tourists travelling to destinations where mosquitoes can be found. Every year hundreds of European tourists return from holidays with diseases such as malaria.

Furthermore, while mosquitoes are predominantly found in warm climates with high humidity, infection may also occur in countries where mosquitoes are not normally found, for example in those cases where the infected mosquito has been transported away from its natural habitat in a long-haul flight.

Accordingly, the fabric according to the invention which is impregnated with a composition comprising cymene is selected from the group comprising tents, bed nets, in particular travel bed nets, hammocks and clothing such as T-shirts, trousers, shirts and hats. In developed countries, in particular in Europe and the US, consumers presently find it more acceptable to use natural products than synthetic compounds. Therefore, it is advantageous to use a natural composition derived from a plant extract to impregnate fabric used by travellers.

The insecticidal composition is also suited for aerosol-based applications, including aerosolized foam applications. Pressurised cans are the typical vehicle for the formation of aerosols. An aerosol propellant that is compatible with the insecticide composition is used. Preferably, a liquefied-gas type propellant is used. Suitable propellants include compressed air, carbon dioxide, butane and nitrogen. The concentration of the propellant in the insecticide composition is from about 5% to about 40% by weight of the insecticide composition, preferably from about 15% to about 30% by weight of the insecticide composition.

The insecticide formulation can also include one or more foaming agents. Foaming agents that can be used include sodium laureth sulphate, cocamide DEA, and cocamidopropyl betaine. Preferably, the sodium laureth sulphate, cocamide DEA and cocamidopropyl are used in combination. The concentration of the foaming agent(s) in the insecticide composition is from about 10% to about 25% by weight, more preferably 15% to 20% by weight of the composition.

When the insecticide formulation is used in an aerosol application not containing foaming agent s), the composition of the present invention can be used without the need for mixing directly prior to use. However, aerosol formulations containing the foaming agents do require mixing (i.e. shaking) immediately prior to use. In addition, if the formulations containing foaming agents are used for an extended time, they may require additional mixing at periodic intervals during use.

An area may also be treated with the insecticidal composition by using a burning formulation, such as a candle, a smoke coil or a piece of incense containing the composition. For example, composition may be comprised in household products such as “heated” air fresheners in which insecticidal compositions are released upon heating, for example, electrically, or by burning.

The invention will be further understood by references to the examples provided below.

### EXAMPLES

### Example 1

### Laval Bioassays

Insect Species Used

All mosquito species used in this study are from colonies held in permanent culture at (London School of Hygiene and Tropical Medicine (LSHTM), see http://www.Lshtm.ac.uk/dcvbu/insect/index.htm). All insects are reared and tested under optimal environmental conditions of 24° C.±2° C., and 80% RH with a 12:12 hour day/night.

Strains used (species, resistance status, colony name, origin)
Anopheles gambiae (susceptible) “KWA” from Tanzania, E. Africa
Anopheles stephensi (susceptible) “Beech” from India
Anopheles albimanus (susceptible) “Mexico” from Mexico
Aedes aegypti (susceptible) “AeAe” from West Africa
Aedes albopictus (susceptible) “Albo” from
Culex quinquefasciatus (susceptible) “Muheza” from Tanzania, E. Africa
Culex pipiens pipiens (susceptible) “Pip” from UK.
Anopheles gambiae (DDT resistant) “ZANDS” from Tanzania, E. Africa
Anopheles gambiae (Pyrethroid Resistant) “VKPR” from E. Africa
Anopheles stephensi (Organophosphate Resistant) “ST Mal” from Pakistan
Anopheles albimanus (Carbamate Resistant) “FEST” from C. America

Methods

The formulation used in the larval bioassays comprises 10% p-cymene in a surfactant solution containing 10-25% of active ingredient and 5-10% of surfactant in the final solution.

The larval bioassays were conducted as per World Health Organisation (WHO) standard larval bioassay protocols (Report of the WHO informal consultation on the evaluation and testing of insecticides, WHO, Geneva, 1996). This procedure uses a range of dilutions of the technical insecticide diluted in absolute ethanol and deionised water and made up into white plastic test pots each holding a total of 250 ml. A range of doses from 0.005 ml/l (lowest) to 1 ml/l (highest) was used (0.005 ml/l, 0.01 ml/l, 0.02 ml/l, 0.05 ml/l, 0.1 ml/l, 0.2 ml, 0.5 ml/l and 1.0 ml/l). Having made up the dilutions above in 250 ml water, 25×3rd instar larvae were added to each pot and the contents gently stirred to mix. In each replicate a negative control was included which contained 1 ml absolute alcohol in 249 ml water. Each pot was scored for mortality at 24 hours. If control mortality was between 5-10%, Abbott's formula was used to correct the mortality data of that run. If control mortality was greater than 10%, the data was discarded and the replicate repeated.

The data was analysed using a minimum of 6 pooled replicates at each dose on each species using a standard log dose×probit analysis statistical programme (Polo Plus version 1.0), to derive LD₅₀ and LD₉₀ with confidence limits and Chi-square for heterogeneity of the regression slope.

### Results

Larval Bioassays

Efficacy of composition as a mosquito larvicide is presented in table 1. Full data sets, raw data and confidence limits and Chi square heterogeneity are shown in Appendix I.

TABLE 1
Larvicide Results

| Species | Status | LD₅₀ | LD₉₀ |
|---|---|---|---|
| An. gambiae | Susceptible | 0.0302 ml | 0.150 ml |
| An stephensi | Susceptible | 0.0248 ml | 0.0989 ml |
| An. albimanus | Susceptible | 0.0242 ml | 0.1005 ml |
| Ae. aegypti | Susceptible | 0.0313 ml | 0.2233 ml |
| Ae. albopictus | Susceptible | 0.0353 ml | 0.1895 ml |
| Cx. quinquefasciatus | Susceptible | 0.0571 ml | 0.2443 ml |
| Cx. pipiens | Susceptible | 0.0267 ml | 0.106 ml |
| An. gambiae | DDT Resistant | 0.0388 ml | 0.1917 ml |
| An. gambiae | Pyrethroid | 0.0392 ml | 0.2206 ml |
| | Resistant | | |
| An. stephensi | OP Resistant | 0.0339 ml | 0.1692 ml |
| An. albimanus | Carbamate | 0.0380 ml | 0.2195 ml |
| | Resistant | | |

TABLE 2
Evidence of cross-resistance

| | | | 95% Confidence |
|---|---|---|---|
| | Resistance | | Limit (CL) for |
| Species | Status | LD₅₀ (ml) | LD₅₀ |
| An. gambiae | DDT Susceptible | 0.0302 | 0.0267-0.0341 |
| An. gambiae | DDT Resistant | 0.0388 | 0.344-0.0437 |
| An. stephensi | OP (malathion) | 0.0248 | 0.0221-0.0277 |
| | Susceptible | | |
| An. stephensi | OP (malathion) | 0.0339 | 0.0300-0.0382 |
| | Resistant | | |
| An. gambiae | Pyrethroid | 0.0302 | 0.0267-0.0341 |
| | Susceptible | | |
| An. gambiae | Pyrethroid | 0.0392 | 0.0345-0.0444 |
| | Resistant | | |
| An. albimanus | Carbamate | 0.0242 | 0.0216-0.0271 |
| | Susceptible | | |
| An. albimanus | Carbamate | 0.0380 | 0.334-0.0431 |
| | Resistant | | |

### Results

The results show that the composition is effective as a mosquito larvicide against a range of medically important mosquito vector species. Biocidal activity is high at comparatively moderate to low doses of active against important malaria vectors from Asia, Africa and Latin America, as well as against potential Culicine vectors of West Nile and other arboviral insectborne diseases and the Aedline vectors of Dengue and Yellow fever. Average LD₉₀ of around 0.1-0.2 ml/l compare favourably with many other existing commercial larvicides currently used in public health vector control programmes. Furthermore, the composition was also found to show no obvious cross resistance to other compounds currently in widespread use, suggesting it has novel mode(s) of action.

### Example 2

### Larval Bioassays Using Different Formulations

### Materials

1) p-cymene 97% (Sigma Chemicals Ltd, UK.Ref. W235601);

2) Thymol 99.5% (Sigma Chemicals Ltd, UK. Ref. T0501);

3) 1:1 mixture of p-cymene and thymol.

Working dilutions of 10% p-cymene or 10% thymol in ethanol were used in the bioassays. The working dilution of the mixture was 5% p-cymene plus 5% thymol in ethanol.

### Methods and Insect Species Used

All mosquito species used in this example correspond to the species used in example 1. Furthermore, the method for the bioassay and analysis of statistical data was also as described in example 1.

### Results

Efficacy of each compound as a mosquito larvicide is presented in table 2.

TABLE 2
Larvicide Results

| | | LD₉₀ | LD₉₀ | LD₉₀ |
|---|---|---|---|---|
| Species | Status | p-Cymene | Thymol | Mixture |
| An. Gambiae | Susceptible | 0.140 ml | 0.177 ml | 0.145 ml |
| An. Stephensi | Susceptible | 0.085 ml | 0.112 ml | 0.101 ml |
| An. Albimanus | Susceptible | 0.088 ml | 0.115 ml | 0.099 ml |
| Ae. Aegypti | Susceptible | 0.198 ml | 0.302 ml | 0.255 ml |
| Ae. albopictus | Susceptible | 0.150 ml | 0.172 ml | 0.170 ml |
| Cx. | Susceptible | 0.215 ml | 0.330 ml | 0.257 ml |
| quinquefasciatus | | | | |
| Cx. pipiens | Susceptible | 0.120 ml | 0.135 ml | 0.122 ml |
| An. Gambiae | DDT Resistant | 0.204 ml | 0.235 ml | 0.198 ml |
| An. Gambiae | Py. Resistant | 0.202 ml | 0.261 ml | 0.224 ml |
| An. Stephensi | OP Resistant | 0.134 ml | 0.177 ml | 0.165 ml |
| An. albimanus | Carbamate | 0.191 ml | 0.224 ml | 0.215 ml |
| | Resistant | | | |

### Conclusions

### Larvicidal Activity

The comparative data shows that both thymol and p-cymene have biocidal activity against a range of mosquito species, with both compounds active within the approximate dose range of 0.1-0.3 ml at a 10% concentration. There was no evidence of cross resistance of either compound to existing insecticide classes (pyrethroids/OP's/Carbamates/Organochlorines) as LD₉₀ figures were similar in susceptible and resistant strains.

### Adult Bioassays

### Insect Species Used

All mosquito species used in this study are from colonies held in permanent culture at LSHTM (see http://www.lshtm.ac.uk/dcvbu/insect/index.htm ). All insects are reared and tested under optimal environmental conditions. of 24° C.±2° C., and 80% RH with a 12:12 hour day/night.

Strains used (species, resistance status, colony name, origin)
Anopheles gambiae (susceptible) “KWA” from Tanzania, E. Africa
Anopheles stephensi (susceptible) “Beech” from India
Anopheles albimanus (susceptible) “Mexico” from Mexico
Aedes aegypti (susceptible) “AeAe” from West Africa
Culex quinquefasciatus (susceptible) “Muheza” from Tanzania, E. Africa
Anopheles gambiae (Pyrethroid Resistant) “VKPR” from E. Africa

### Compositions Used in the Adulticide Assays

The composition used for the experiments for WHO adult bioassay papers comprises 10% p-cymene and was diluted in olive oil/acetone. The composition used as EC was 10% p-cymene used in water for impregnation of polyester netting at a rate of 0.1 g/m².

### Methods

WHO adult mosquito bioassays were conducted on all of the above species as both standard WHO impregnated paper bioassays or as impregnated netting tests.

### Adult WHO Paper Tests

These were conducted as per standard WHO protocol using impregnated papers in WHO bioassay tubes as described in WHO TRS 1963 and detailed at http://whqlibdoc.who.int/hq/1996/CTD WHOPES IC 96.1.pdf In summary, in standard WHO protocol using impregnated papers, dosages of the composition to be tested are applied to Whatman filter paper. The paper is then air dried and inserted into WHO tubes. Mosquitoes are then placed into the tubes and exposed to the treated paper. From the results the prohibit mortality/log dose regression and hence the LD₅₀ can be calculated.

The active was diluted to 1% in olive oil and stored at 4° C. 0.7 ml this stock solution was mixed with 1.3 ml acetone, mixed then spread evenly over a piece of Whatman's no. 1 filter paper measuring 150×120 mm, to give a 1% paper at a spreading rate of 3.6 g/m². Exposure papers were used to line WHO plastic adult testing tubes and held in place with a wire spring clip. Papers were held in aluminum foil at 4° C. between use but brought down to testing room temperature prior to each test. Batches of 25 adult female mosquitoes of 2-4 days post-eclosion were exposed to these impregnated papers for a period of 2 hours before being returned to a resting tube and held overnight with glucose prior to scoring mortality.

### Adult Testing on Impregnated Netting

In order to get an indication as to the efficacy of the composition as a potential material for impregnation of bed nets a series of netting bioassays were undertaken using the. standards WHO bioassay cone method. A series of 250×250 mm squares of standard polyester netting samples were impregnated at a rate of 0.1 g/m² using an EC formulation suspended in deionised water. After allowing the nets to dry a WHO bioassay cone was fixed over the net and 20 adult female mosquitoes of 2-4 days post-eclosion were placed into the cone and the top hole plugged with cotton wool. After an exposure period of 1 hour the knock-down was recorded and the females removed by mouth aspirator and transferred to a holding cup with glucose for mortality to be scored at 24 hours.

### Results

### WHO Adulticide Paper Assays

| Species/resistance/strain | 24 hr mortality |
|---|---|
| Anopheles gambiae (susceptible) “KWA” | 43% |
| Anopheles stephensi (susceptible) “Beech” | 58% |
| Anopheles albimanus (susceptible) “Mexico” | 40% |
| Aedes aegypti (susceptible) “AeAe” | 29% |
| Culex quinquefasciatus (susceptible) “Muheza” | 31% |
| Anopheles gambiae (Pyrethroid resistant) “VKPR” | 45% |

### WHO Impregnated Netting Bioassay Cone Assays

Knock-down and kill of Anopheles gambiae (KWA) following 1 hour exposure to impregnated netting at 0.1 g/m² KD=knock-down

| | | 24 hr |
|---|---|---|
| Species/strain | 1 Hr KD | mortality |
| Anopheles gambiae (susceptible) “KWA” | 34% | 25% |
| Anopheles stephensi (susceptible) “Beech” | 47% | 36% |
| Anopheles albimanus (susceptible) “Mexico” | 35% | 29% |
| Aedes aegypti (susceptible) “AeAe” | 27% | 21% |
| Culex quinquefasciatus (susceptible) “Muheza” | 28% | 22% |
| Anopheles gambiae (Pyrethroid resistant) | 38% | 27% |
| “VKPR” | | |

### Results

### Residual Effects Against Adults

The results of our experiments using the composition against the adult stages of mosquitoes show that in addition to acting as a biocide against the immature larval stages of mosquitoes, the composition can also be used as an adulticide against a range of medically important mosquito species.

### Use in “Indoor Residual Spraying” (IRS)

By formulating the technical material into an oil formulation, application to filter paper and utilization in the standard WHO adult bioassay tube methodology, we found that the active has significant biocidal activity against all of the mosquito genus and species tested. Use of insecticides in IRS programmes against mosquito vectors is widely practiced in most tropical Countries with insect-borne disease problems. Such programmes traditionally use simple back-pack type sprayers to apply a residual surface coating to the walls and roof inside houses which then kills insects as they rest on these surfaces overnight, either before of after feeding. The fact that the composition was found to cause significant mortality 24 hours exposure is very encouraging as this would make it comparable to existing pesticides used in this manner, such as organophosphates and carbamates.

### Use to Impregnate Bed Nets

The relatively rapid knock-down and mortality found by using the EC formulation of the composition as in ITN was particularly unexpected, and leads to a very important potential use for the compound. ITNs are only effective when impregnated with an active which induces fast knock-down and rapid kill, as prolonged exposure to the bed net without these would result in a mosquito being able to find and enter any hole or gap in the net or to locate and feed on any flesh up against it. For this reason, the only class of insecticides which have proven useful for ITN treatments to date are the synthetic pyrethroids. Other common classes, such as the organophosphates, carbamates and organochlorines, have not been suitable. It is both unusual and unexpected that a plant-derived active should exhibit both KD and mortality on netting. In particular, it may overcome a potentially very serious problem as there is an increasing trend towards the development of resistance to the current ITN treatment pyrethroids, which could render them less or ineffective in the future. As ITNs are the mainstay of vector control in sub-Saharan Africa, this would be a severe blow to malaria control in the region. One of the most pressing needs in vector control at this time is the search for alternatives to pyrethroids for use on ITN.

A further important factor is that KD and mortality following use against a known pyrethroid-resistant mosquito strain (VKPR), was found to be the same as that of a fully susceptible strain (KWA), so there is no obvious sign of cross-resistance between the two compounds. It is also an important finding that of the three main disease vector genus of mosquitoes we tested, it is the one responsible for transmitting malaria, Anopheles, which has proven to be most susceptible to the composition on netting, and it is these species, rather than Aedes or Culex species, which are controlled through the use of ITNs.

1. A method for controlling mosquito larvae of a genus other than Culex comprising applying a larvicide composition comprising an effective amount of cymene.

2. The method according to claim 1 wherein the genus is Anopheles or Aedes.

3. The method according to claim 1 wherein the genus is Anopheles

4. The method according to claim 3 wherein the mosquito larvae are of the species Anopheles gambiae, Anopheles stephensi or Anopheles albimanus.

5. The method according to claim 1 wherein the genus is Aedes.

6. The method according to claim 5 wherein the mosquito larvae are of the species Aedes aegypti or Aedes albopictus.

7. The method according to claim 1 wherein the composition comprises a plant extract.

8. The method according to claim 7 wherein the extract is derived from Rabdosia melissoides.

9. A granular composition comprising a larvicidally effective amount of cymene.

10. A granular composition according to claim 9 comprising a plant extract.

11. A method for controlling mosquito larvae comprising applying a granular composition comprising a larvicidally effective amount of cymene to said larvae or to a locus where control is desired.

12. The method as claimed in claim 11 wherein the mosquito larvae are of the genus Culex

13. The method as claimed in claim 12 wherein the mosquito larvae are of the species Culex quinquefasciatus or Culex pipiens.

14. The method as claimed in claim 11 wherein the mosquito larvae are of the genus Aedes.

15. The method according to claim 14 wherein the mosquito larvae are of the species Aedes aegypti or Aedes albopictus.

16. The method according to claim 11 wherein the mosquito larvae are of the genus Anopheles.

17. The method according to claim 16 wherein the mosquito larvae are selected from the group consisting of Anopheles gambiae, Anopheles stephensi, Anopheles albimanus.

18. A composition comprising a larvicidally effective amount of cymene formulated as a residual spray.

19. A composition comprising a larvicidally effective amount of cymene which is coated on and/or absorbed into a fabric.

20. A composition according to claim 19 wherein the fabric comprises natural and/or synthetic fibers.

21. A composition according to claim 19 wherein the fabric is a bed net, a tent or an item of clothing.

22. A composition according to claim 18 comprising a plant extract.

23. A composition according to claim 22 wherein the extract is derived from Rabdosia melissoides.

24. A method for controlling mosquito adults, said method comprising applying an effective amount of a composition comprising cymene to mosquitoes or to a locus where control is desired.

25. The method according to claim 24 wherein the composition comprises a plant extract.

26. The method according to claim 25 wherein the extract is derived from Rabdosia melissoides

27. The method according to claim 24 wherein the composition is as defined in claim 18.

28. The method according to claim 24 wherein the mosquitoes are of the genus Anopheles or Aedes.

29. The method according to claim 28 wherein the genus is Anopheles.

30. The method according to claim 29 wherein the mosquitoes are selected from the group consisting of Anopheles gambiae, Anopheles stephensi or Anopheles albimanus.

31. The method according to claim 28 wherein the genus is Aedes.

32. The method according to claim 31 wherein the mosquitoes are of the species Aedes aegypti or Aedes albopictus.

33. The method according to claim 24 wherein the mosquitoes are of the genus Culex.

34. The method according to claim 33 wherein the mosquitoes are of the species Culex pipiens or Culex quinquefasciatus.

35. A granular composition according to claim 10 wherein the plant extract is derived from Rabdosia melissoides.

36. A composition according to claim 19 comprising a plant extract.

37. A composition according to claim 36 wherein the extract is derived from Rabdosia melissoides.

38. The method according to claim 24 wherein the composition is as defined in claim 19.
